(19) United States
(12) Patent Application Publication
(10) Pub. No.: US 2008/0100048 A1
(43) Pub. Date: May 1, 2008

(54) Gas Bag module

(75) Inventor: Werner Freisler, Aalen (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automobile GmbH

(21) Appl. No.: 11/974,823

(22) Filed: Oct. 16, 2007

(30) Foreign Application Priority Data
Oct. 25, 2006 (DE) 10 2006 050 310.4

(51) Int. Cl. B60R 21/26

(52) U.S. Cl. 280/736

(57) ABSTRACT

A vehicle occupant restraint system has a gas bag module with a gas generator and a housing with an exit opening. The housing is through-shaped and forms a receptacle that is open on one side. A folded gas bag is received in the housing which, upon activation of the gas bag module, unfolds out of the receptacle in a deployment direction. The gas generator is arranged in the receptacle such that a longitudinal axis of the gas generator is closer to the exit opening than a longitudinal axis of the receptacle.

### FIELD OF THE INVENTION

The present invention relates to a vehicle occupant restraint system.

### BACKGROUND OF THE INVENTION

Gas bag modules of a type comprising a gas generator and a trough-shaped housing containing a folded gas bag which, upon an activation of the gas bag module, unfolds out of the housing are widely used. They are employed for knee protector systems or front passenger gas bags, for example, but are also used, in an upended position, in backrests of seats for the provision of side gas bags.

Such gas bag modules are simple as regards manufacturing and equipment with gas generator and a gas bag, and can be easily adapted to many different sizes and installation sites.

Primarily in large-area gas bags there is the risk, however, of the housing widening during deployment of the gas bag, i.e. of an exit opening thereof changing its shape because the side walls of the housing bulge. Since this has adverse effects, of course, it needs to be prevented by providing a complex housing configuration. Rib structures may be used for this purpose, for example, or else the housing may be produced from a sturdier material, which, of course, will result in an increase in cost and weight of the gas bag module. This so-called bulging effect, which is undesirable, becomes more likely to occur the larger the surface area of the gas bag, because this is, of course, accompanied by an increase in the size of the housing, which will make the side faces more instable, and furthermore because the gas generator has to generate a stronger gas flow owing to the large filling volume, adding to the stress on the housing.

It is an object of the invention to provide a gas bag module in which the bulging effect is reduced.

### BRIEF SUMMARY OF THE INVENTION

For this purpose, a vehicle occupant restraint system has a gas bag module with a gas generator and a housing with an exit opening. The housing is through-shaped and forms a receptacle that is open on one side. A folded gas bag is received in the housing which, upon activation of the gas bag module, unfolds out of the receptacle in a deployment direction. The gas generator is arranged in the receptacle such that a longitudinal axis of the gas generator is closer to the exit opening than a longitudinal axis of the receptacle. This geometric arrangement results in a shift in the points of application of the laterally acting forces developing during the deployment of the gas bag towards the exit opening and partly totally out of the housing. As a result, the stress on the housing is lower, so that there is less widening of the housing. Therefore, the measures to be taken for stiffening the housing may be reduced or even eliminated altogether. The longitudinal axes of the generator and the receptacle which are usually cylindrical parts is defined by their centres of area, seen in longitudinal direction.

Preferably, the gas generator is a known elongated tubular gas generator. It may be a generator based purely on solid propellant, a generator based purely on pressurized gas, or a hybrid form.

As viewed along the deployment direction, the longitudinal axis of the gas generator is preferably arranged behind the longitudinal axis of the receptacle, and the longitudinal axis of the gas generator is offset in relation to the longitudinal axis of the receptacle in a direction perpendicular to the longitudinal axis of the receptacle. In other words, the gas generator, as viewed in a section perpendicular to the parallel axes of the gas generator and the receptacle, is located off a centre of area of the receptacle offset in relation to the longitudinal axis of the receptacle towards the exit opening and at the same time laterally offset in relation to the longitudinal axis of the receptacle.

It is further advantageous for a vertical axis of the housing to be located in front of the longitudinal axis of the gas generator in the deployment direction. Also with such a geometry, the gas generator is arranged laterally offset in relation to the longitudinal axis of the receptacle or of the housing and closer to the exit opening.

In a preferred embodiment of the invention, the receptacle has first and second longitudinal side faces and the gas generator is arranged on the first longitudinal side face such that it is located in the vicinity of an outer edge of the first longitudinal side face and, therefore, in the vicinity of the exit opening. Unlike in conventional arrangements, in which the gas generator is fastened to the base of the module housing or of the receptacle, provision is made according to the invention for the gas generator to be arranged on and, if possible, fastened to, one of the longitudinal side faces of the receptacle. This arrangement allows in a simple way to place the gas generator laterally offset from the longitudinal axis of the receptacle and at the same time to dispose it close to the exit opening.

In line with the geometry already described above, the longitudinal axis of the gas generator is preferably located closer towards the outer edge than the longitudinal axis of the receptacle.

It is preferred for the gas generator to be arranged spaced apart from a base surface of the housing.

The distance of an outer wall of the gas generator from the outer edge or from the exit opening should, if possible, be less than 2 cm. The gas generator could also be situated directly at the outer edge.

The first longitudinal side face, with which the gas generator is in contact, may be made to be stepped in order to allow the gas generator to be fastened, or else to better adjust the housing to the fitting conditions in the vehicle.

Preferably, the height of the first longitudinal side face is lower than that of the second. This makes it easier to arrange the gas generator close to the outer edge of the longitudinal side face and at the same time to provide sufficient room for the folded gas bag in the receptacle.

In a preferred embodiment of the invention, the height of the first longitudinal side face amounts to approximately twice the diameter of the gas generator.

In order to further reduce the introduction of force into the housing, the gas generator may include an outflow region having an outflow direction which is directed obliquely to the exit opening. In this arrangement, the gas generator is preferably disposed such that the stream of outflowing gas has to cover as long a distance as possible until it strikes onto one of the longitudinal side faces of the receptacle. This, too, reduces the forces acting on the longitudinal side faces of the receptacle and thus the degree of bulging.

The invention may be made use of to advantage in knee gas bag modules, but it may also be used in other suitable gas bag modules such as those described above, for example.

In a knee gas bag module the exit opening is preferably directed substantially opposite to a longitudinal direction of the vehicle, so that the gas bag can unfold opposite to the longitudinal direction of the vehicle and towards the knees of the vehicle occupant if the gas bag module is fastened below a steering column.

### SHORT DESCRIPTION OF THE DRAWINGS

FIG. 1 shows a diagrammatic perspective view of a gas bag module according to the invention; and

FIG. 2 shows a diagrammatic sectional view of the gas bag module according to the invention as seen in FIG. 1.

### DETAILED DESCRIPTION OF A PREFERRED EMBODIMENT

The gas bag module 10, illustrated in the Figures, of a vehicle occupant restraint system has a trough-shaped housing 12 made of metal or a suitable plastic material. The housing 12 has first and second longitudinal side faces 14, 16, which are located opposite each other and form the longitudinal sides of a receptacle 18. Two end faces 20, 22 terminate the receptacle 18 perpendicularly to the longitudinal side faces 14, 16. All of the side and end faces 14, 16, 20, 22 terminate at a base surface 24, whereas the outer edges 34, opposite to the base surface 24, of the longitudinal side faces 14, 16 and of the end faces 20, 22 define an exit opening 26.

Prior to activation of the gas bag module 10, a folded gas bag 28 is arranged inside the receptacle 18 (shown in the unfolded condition in FIG. 2). Further accommodated in the receptacle 18 is a gas generator 30, in this case an elongated tubular gas generator. The gas generator 30 is bolted to the first longitudinal side face 14 by means of a known fastener 32, in this case a clamp which is connected to a threaded bolt.

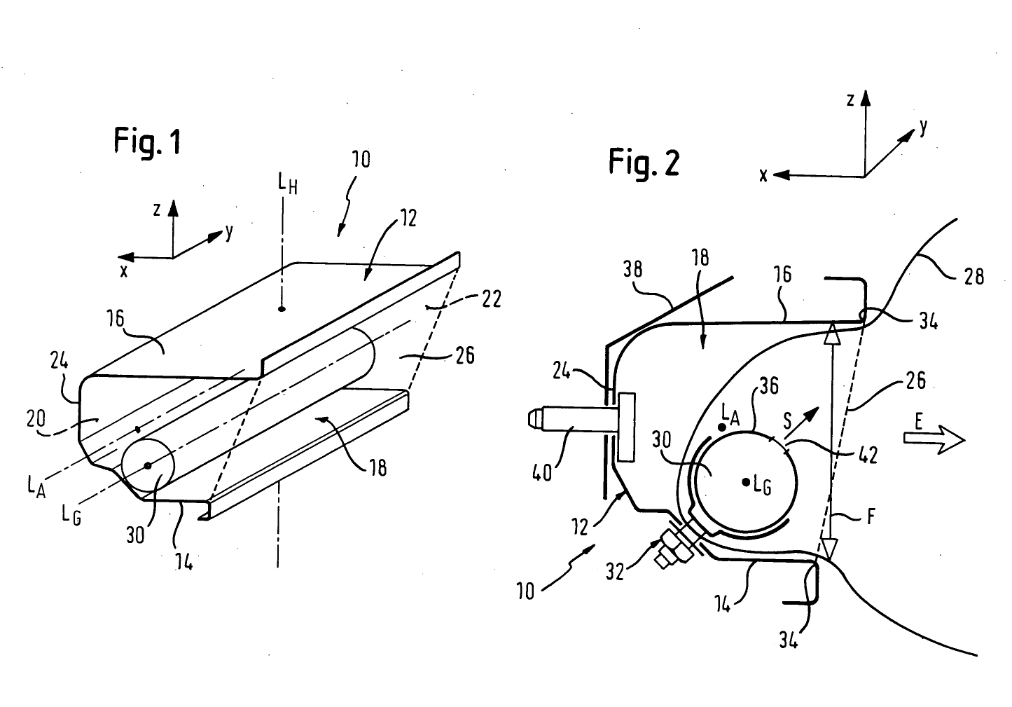

The housing 12 or, to be more precise, the receptacle 18 has a longitudinal axis L_{A}, which passes through the centres of area of the two end faces 20, 22 (which are of identical shape here), as is shown in FIG. 1. The receptacle 18 further has a vertical housing axis L_{H}, which results from the centres of area of the longitudinal side faces 14 and 16.

The gas generator 30 has a longitudinal axis L_{G} and is arranged such that its longitudinal axis L_{G} is parallel to the longitudinal axis L_{A} of the receptacle 18.

The longitudinal axis L_{G} of the gas generator 30 is offset in relation to the longitudinal axis L_{A} of the receptacle 18 towards the exit opening 26. Moreover, in the example shown, the longitudinal axis L_{G} of the gas generator 30 is offset in relation to the longitudinal axis L_{A} of the receptacle 18 in a direction perpendicular to the longitudinal axis L_{A} of the receptacle 18, in this case opposite to the z-direction.

Viewed along a deployment direction E of the gas bag 28, the longitudinal axis L_{G} of the gas generator 30 is located behind the longitudinal axis L_{A} of the receptacle. The vertical housing axis L_{H} is located in front of the longitudinal axis L_{G} of the gas generator 30, likewise as related to the deployment direction E.

The gas generator 30 is thus placed at a distance from the base surface 24 of the receptacle 18 and is arranged on the first longitudinal side face 14 in the vicinity of the outer edge 34, defining the exit opening 26, of the first longitudinal side face 14. The distance of an outer wall 36 of the gas generator 30 from the exit opening 26 or from the outer edge 34 is less than 2 cm. The gas generator 30 could also be arranged in such a way that its outer wall 36 is located directly at the outer edge 34 or at the level of the exit opening 26.

In any case, the longitudinal axis L_{G} of the gas generator 30 is located closer towards the outer edge 34 than the longitudinal axis L_{A} of the receptacle 18.

In the embodiment shown, the first longitudinal side face 14 is made to be stepped, the gas generator 30 being fixed in place by means of the fastener 32 in the region of the step.

The first longitudinal side face 14 is lower in height, i.e. has a smaller distance of the outer edge 34 from the base surface 24, than the second longitudinal side face 16. In the embodiment shown, the height of the first longitudinal side face 14 corresponds approximately to twice the diameter of the gas generator 30.

The gas bag module 10 illustrated is a knee gas bag module which is attached beneath a steering column (not shown) to a component 38 fixed to the vehicle (shown diagrammatically in FIG. 2). To this end, by means of a conventional fastening means 40 the base surface 24 of the housing 12 is connected to the vehicle-fixed component 38.

The gas bag module 10 is arranged such that the exit opening 26 is directed substantially opposite to a longitudinal direction x of the vehicle (which points in the direction of travel of the vehicle). This results in that the longitudinal axis L_{G} of the gas generator 30 is arranged below the longitudinal axis L_{A} of the receptacle 18 in the z-direction.

Upon activation of the gas bag module 10, the gas bag 28, initially arranged folded in the receptacle 18, exits from the housing through the exit opening 26 in a deployment direction E. The gas bag is caused to exit by gas flowing out of the gas generator 30, filling the gas bag 28. The gas generator 30 has one or more predefined outflow regions 42 (indicated in FIG. 2, with the actual configuration of the outflow region 42 being left to the discretion of a person of ordinary skill in the art), so that the gas leaves the gas generator 30 in a main flow direction S.

When the gas bag 28 is inflated and exits from the housing 12, it exerts lateral forces on the housing 12 and particularly on the longitudinal side faces 14, 16. Owing to the arrangement of the gas generator 30 in relation to the longitudinal axis L_{A} of the receptacle 18, the principal forces occur at the places marked by the tips of the arrow F in FIG. 2. The principal load on the second longitudinal side face 16 develops near the outer edge 34, while on the opposite, first longitudinal side face 14 the point of maximum force introduction by the gas bag 28 is already completely outside of the housing 12. The result of this distribution of force is that during its deployment the gas bag 28 can not rest against the two longitudinal side faces 14, 16 and push them apart. Rather, one of the points of force introduction on the housing 12 is eliminated, so that the housing 12 is widened considerably less.

Supporting the gas bag 28 at the second longitudinal side face 16 presents no problem, so that the housing 12 or receptacle 18 may be made deeper on this side to provide more room for the folded gas bag 28.

The arrangement of the gas generator 30 in relation to the longitudinal axis L_{A} of the receptacle 18, the exact shape and height of the longitudinal side faces 14, 16, and the arrangement of the main flow direction S of the gas generator 30 may be adjusted to one another at the discretion of a person of ordinary skill in the art in order to minimize the widening of the exit opening 26 depending on the particular purpose of application and the particular exact housing shape.

1. A vehicle occupant restraint system comprising a gas bag module (10) having
a gas generator (30) and
a housing (12) with an exit opening (26), the housing (12) being through-shaped and forming a receptacle (18) that is open on one side,
a folded gas bag (28) being received in the housing (12) which, upon activation of the gas bag module (10), unfolds out of the receptacle (18) in a deployment direction (E),
the gas generator (30) being arranged in the receptacle (18) such that a longitudinal axis (L_{G}) of the gas generator (30) is closer to the exit opening (26) than a longitudinal axis (L_{A}) of the receptacle (18).

2. The vehicle occupant restraint system according to claim 1, wherein, as related to the deployment direction (E), the longitudinal axis (L_{G}) of the gas generator (30) is located behind the longitudinal axis (L_{A}) of the receptacle (18), and the longitudinal axis (L_{G}) of the gas generator (30) is offset in relation to the longitudinal axis (L_{A}) of the receptacle (18) in a direction perpendicular to the longitudinal axis (L_{A}) of the receptacle (18).

3. The vehicle occupant restraint system according to claim 1, wherein in the deployment direction (E), a vertical axis (L_{H}) of the housing is located in front of the longitudinal axis (L_{G}) of the gas generator (30).

4. The vehicle occupant restraint system according to claim 1, wherein the receptacle (18) has first and second longitudinal side faces (14, 16) and the gas generator (30) is arranged on the first longitudinal side face (14) such that it is located in the vicinity of an outer edge (34) of the first longitudinal side face (14).

5. The vehicle occupant restraint system according to claim 4, wherein the longitudinal axis (L_{G}) of the gas generator (30) is located closer towards the outer edge (34) than the longitudinal axis (L_{A}) of the receptacle (18).

6. The vehicle occupant restraint system according to claim 4, wherein the distance of an outer wall (36) of the gas generator (30) from the outer edge (34) is less than 2 cm.

7. The vehicle occupant restraint system according to claim 4, wherein the gas generator (30) is situated directly at the outer edge (34).

8. The vehicle occupant restraint system according to claim 4, wherein the first longitudinal side face (14) is made to be stepped.

9. The vehicle occupant restraint system according to claim 4, wherein the first longitudinal side face (14) is lower in height than the second.

10. The vehicle occupant restraint system according to claim 4, wherein the height of the first longitudinal side face (14) corresponds approximately to twice the diameter of the gas generator (30).

11. The vehicle occupant restraint system according to claim 1, wherein the gas generator (30) includes an outflow region (42) having an outflow direction (S) directed obliquely to the exit opening (26).

12. The vehicle occupant restraint system according to claim 1, wherein the receptacle (18) has a base surface (24) and the gas generator (30) is arranged spaced apart from the base surface (24).

13. The vehicle occupant restraint system according to claim 1, wherein the gas bag module (10) is a knee gas bag module.

14. The vehicle occupant restraint system according to claim 13, wherein the exit opening (26) is directed substantially opposite to a longitudinal direction (x) of the vehicle.
